(19) United States
(12) Patent Application Publication
(10) Pub. No.: US 2004/0179301 A1
(43) Pub. Date: Sep. 16, 2004

(54) Disc cartridge

(75) Inventor: Junichi Nakamikawa, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/793,221

(22) Filed: Mar. 5, 2004

(30) Foreign Application Priority Data
Mar. 10, 2003 (JP) 063103/2003

(51) Int. Cl. G11B 23/03

(52) U.S. Cl. 360/133

(57) ABSTRACT

To ensure smooth rotation of a rotary shutter.

A rotatably holding member for rotatably holding the rotary shutter is provided on an upper shell, and an upper shutter member and lower shutter members are joined to one another at their side walls.

### BACKGROUND OF THE INVENTION

1. Field of the Invention

The present invention relates to disk cartridges comprising a flat housing constituted by upper and lower shells, and an information recording medium rotatably enclosed within the housing. More specifically, the present invention relates to a shaft supporting mechanism of a rotary shutter for opening and closing an opening formed in the housing in order to allow a recording/reproducing head to access the information recording medium.

2. Description of the Related Art

Conventionally, mobile equipment such as digital cameras, etc., use as recording media very small magnetic disk cartridges called “clik!™” as described, for example, in U.S. Pat. No. 6,133,544, U.S. Pat. No. 5,995,346, and A. Oshima “PASOKON KAITAI SHINSHO (New PC Construction Details)” Soft Bank Publishing, Apr. 10, 2000, pp.52-53.

FIG. 4 shows an example of a conventional very small magnetic disk cartridge called “clik!™”. A disk cartridge 1 illustrated in FIG. 4, for example, comprises a housing (width 50 mm, depth 55 mm, thickness 1.95 mm) which has upper and lower shells 3, 4 formed of flat thin metal sheets; and an approximately 1.8 inch (46.5 mm) diameter disk-shaped information-recording medium (magnetic disk) 5 having a 40 MB storage capacity and accommodated in the housing. The upper and lower shells 3, 4 have an opening to allow a disk drive (not shown) to access the magnetic disk. The lower shell 4 has a center hole 4a for exposing towards the outside a center core 10 which is centrally disposed in the information-recording media 5. Further, a rotary shutter 7 for opening and closing the opening is provided within the upper and lower shells 3, 4.

This rotary shutter 7 is constituted by upper and lower shutter members 7U, 7D. The upper shutter member 7U is rotatably supported by a cylinder 3a formed in the upper shell 3. An anti-displacement member 11, called a center pin, for preventing the upper shutter member 7U from being disengaged from the cylinder 3a due to displacement is secured by welding at the distal end of the cylinder 3a.

On the other hand, the lower shutter member 7D has a large diameter cylindrical portion 7Da that extends around the center hole 4a and projects downward. After the cylindrical portion 7Da is inserted into the center hole 4a of the lower shell 4, the distal end of the cylinder 7Da is caulked such that a caulked portion 12 for preventing the aforementioned disengagement is formed and the lower shutter member 7D is rotatably supported thereby.

The upper member 7U and lower member 7D is not joined but engaged with each other. More specifically, a protrusion protruding towards the lower shutter member 7D is formed on the side wall 7B of the upper shutter member 7U, and a recess to be matingly engaged with the protrusion is formed on the side wall 7B of the lower shutter member 7D. Thus, when a rotational force is applied to the lower shutter member 7D by the disk drive, the upper shutter member 7U is also moved to rotate as one with the lower shutter member 7D.

As is mentioned above, since the lower shutter member 7D is held rotatably with respect to the lower shell 4 by the caulking, the lower shell 4 is in frictional contact with the caulked portion 12 of the lower shutter member 7D during rotation of the lower shutter member 7D relative to the lower shell 4. This arises a problem that a larger force becomes necessary for opening and closing the rotary shutter 7 because of the sliding friction of the lower shutter member.

Repeating the opening and closing operation of the rotary shutter 7 may generate dust particles at the caulked portion of the lower shutter member 7D as a result of wear due to friction. These dust particles cause resistance during opening and closing of the rotary shutter 7, and impairs smooth opening and closing operations.

### SUMMARY OF THE INVENTION

In view of the foregoing, it is an object of the invention to provide a disk cartridge that ensures smooth rotational movement of the rotary shutter.

According to the present invention, there is provided a disk cartridge comprising: a flat housing having upper and lower shells; and a disk-shaped information recording medium which has a center core centrally attached thereto and is rotatably accommodated in the flat housing, the housing including an opening to allow a recording/reproducing head of a drive unit to access a surface of the information recording disk, and a rotary shutter for opening and closing the opening, wherein the housing has a rotatably holding portion for rotatably holding the rotary shutter, the rotatably holding portion being provided only on the upper shell; and wherein the rotary shutter comprises an upper shutter member which is rotatably held by the rotatably holding member, and a lower shutter member which is joined at its side wall to the upper shutter member.

The upper shutter member and the lower shutter member may be joined to one another by contiguously joining their entire sidewalls via which the upper shutter member and the lower shutter member contact with each other, or may be joined by partially joining the sidewalls via which the upper shutter member and the lower shutter member contact with each other.

The lower shell may have a generally circular center hole for exposing a center core towards the outside, and the lower shutter member may have a simple cylindrical portion to be inserted into the center hole.

As used herein, “simple cylindrical portion” means a cylindrical portion which does not have a caulked portion at the distal end thereof, formed by caulking.

In accordance with the disk cartridge of the present invention, a rotatably holding member for rotatably holding the rotary shutter is provided only on the upper shell, and the rotary shutter is made by joining an upper shutter member and lower shutter member to one another. This eliminates the need for caulking the lower shutter member to the lower shell in order to rotatably hold the lower shutter member as in the conventional way. As a result, the sliding friction at the caulked portion is eliminated. Consequently, smooth movement of the rotary shutter is ensured.

Further, the caulked portion between the lower shutter member and the lower shell becomes unnecessary, which avoids production of the dust particles as a result of wear due to sliding at the caulked portion, thereby preventing deposition of the dust particles on the information recording medium.

Providing the lower shell with a generally circular center hole for exposing a center core towards the outside and providing the lower shutter member with a cylindrical portion to be inserted into the center hole allows the rotatably holding member to serve to guide the rotational movement of the upper shutter member and allows the cylindrical portion and the center hole to serve to guide the rotational movement of the lower shutter member. This can reduce deflections of the rotary shutter when it rotates.

### BRIEF DESCRIPTION OF THE DRAWINGS

FIG. 1A is a plan view, FIG. 1B is a side view, and FIG. 1C is a bottom view of a disk cartridge according to a preferred embodiment of the invention with the rotary shutter closed;

FIG. 2A is a plan view and FIG. 2B is a bottom view of the disk cartridge according to the preferred embodiment of the invention with the rotary shutter open;

FIG. 3 is a schematic view of the disk cartridge shown in FIGS. 1A and 2B illustrating an embodiment of an assembled configuration of upper and lower shells and rotary shutter; and

FIG. 4 is a schematic view showing one example of a conventional disk cartridge.

### DESCRIPTION OF THE PREFERRED EMBODIMENTS

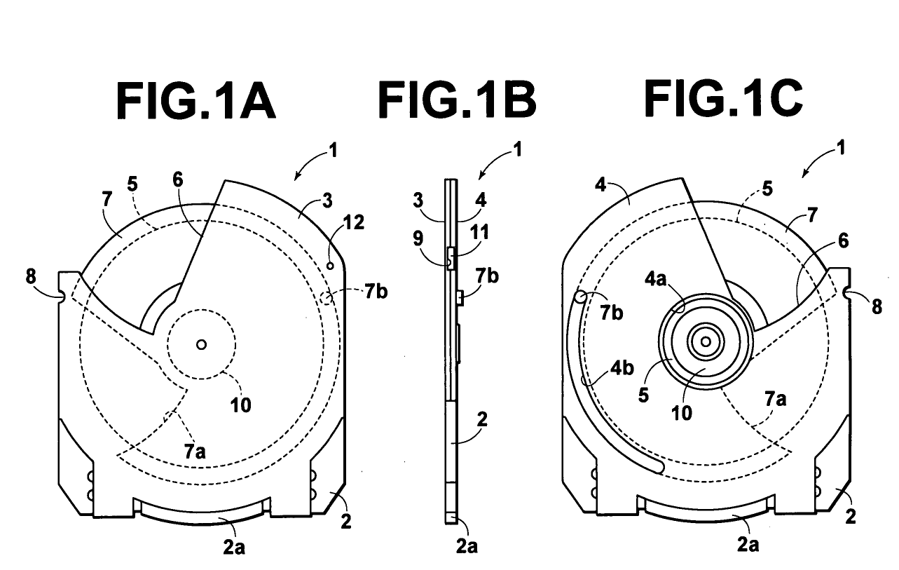

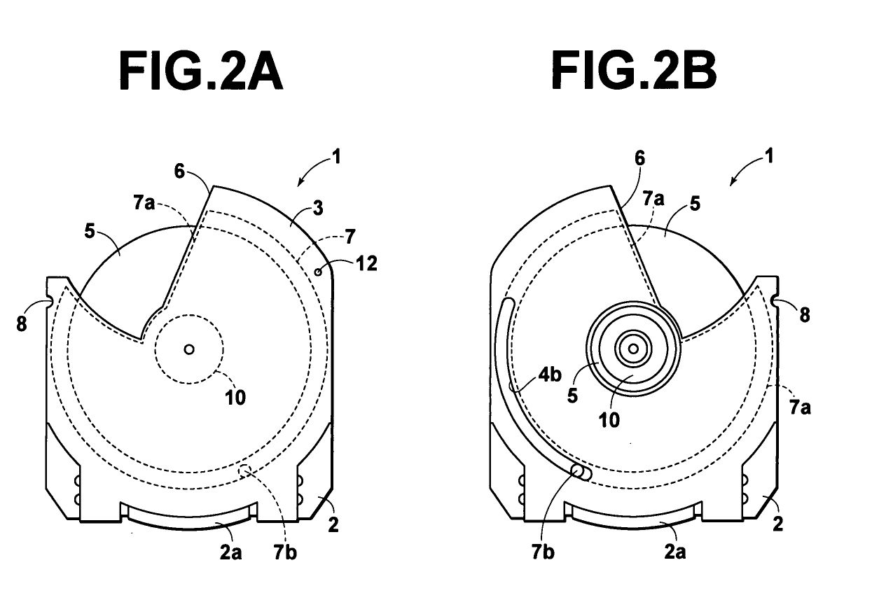

Hereinafter, an embodiment of the present invention will be described in detail with reference to the drawings. FIGS. 1A to 1C and FIGS. 2A and 2B illustrate a disk cartridge according to a preferred embodiment of the invention. Specifically, FIG. 1A is a plan view, FIG. 1B is a side view, and FIG. 1C is a bottom view of the disk cartridge, with a rotary shutter 7 closed, while FIG. 2A is a plan view and FIG. 2B is a bottom view of the disk cartridge in FIGS. 1A to 1C, shown with the rotary shutter 7 open.

This disk cartridge 1 comprises a flat housing (width 50 mm, depth 55 mm, thickness 1.95 mm); and an information-recording medium 5 which is approximately 1.8″ (46.5 mm) diameter magnetic disk and rotatably accommodated in the flat housing. The housing is constituted by a resin frame 2 including a push portion 2a for pushing the disk cartridge into a disk drive, for example, by a finger or the like, and upper and lower shells 3, 4 formed of thin metal sheets. The lower shell 4 has a center hole 4a for exposing a center core 10, which is centrally located in the information-recording medium 5, towards the exterior.

Each of the upper and lower shells 3, 4 is provided with a wedge-shaped opening 6 to allow a magnetic head of the disk drive, into which the cartridge 1 is loaded by insertion, to access the surface of the information-recording medium 5. A rotary shutter 7 for opening and closing the opening 6 is disposed within each of the upper and lower shells 3, 4.

The rotary shutter 7 is formed in a generally disk-like shape, and provided with an opening 7a which has substantially the same shape as the opening 6 of the housing. The rotary shutter 7 further has a shutter knob 7b which projects towards the lower shell 4, and the lower shell 4 includes an arcuate apeature 4b concentric with the rotary shutter 7 into which the shutter knob 7b is inserted. The shutter knob 7b moves along the arcuate apeature 4b from a state in which the opening 6 of the rotary shutter 7 is closed as shown in FIG. 1, thereby the opening 7a of the rotary shutter 7 is positioned to overlap with the opening 6 of the housing to expose the information-recording medium 5, as shown in FIGS. 2A and 2B.

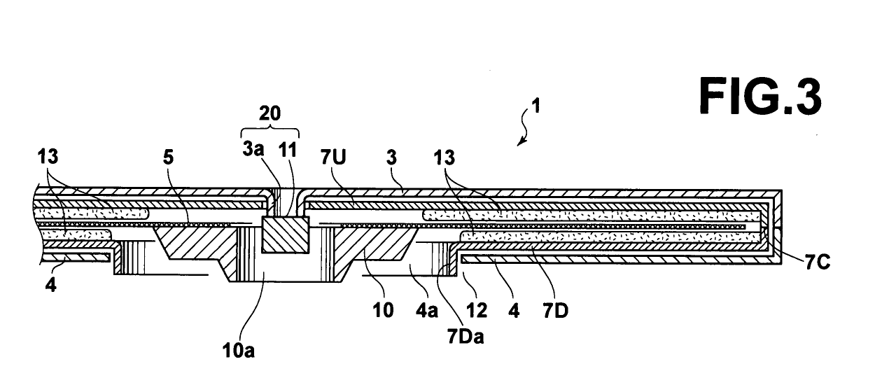

FIG. 3 is sectional view of the disk cartridge 1 shown in FIGS. 1A to 2B. Referring to FIG. 3, the rotary shutter 7 is constituted by upper and lower shutter members 7U, 7D formed of thin metal sheets. A liner 13 for wiping off dirt and dust deposited on the information recording medium 5 is interposed between each of the upper and lower shutter members 7U, 7D and the information recording medium 5.

The upper shutter member 7U and the lower shutter member 7D are joined to one another at their side walls 7C, for example, by laser welding, adhesive, and the like. Thus, the upper shutter member 7U and the lower shutter member 7D are made integral with each other, and when force is exerted on the shutter knob 7b (see FIG. 1A to FIG. 2B) of the lower shutter member 7D, a rotational force is also transmitted to the upper shutter member 7U as well as the lower shutter member 7D.

The upper shutter member 7U is rotatably held by a rotatably holding portion 20 formed in the upper shell 3. The rotatably holding portion 20 comprises a cylinder 3a which projects towards the upper shutter member 7U from the upper shell 3, and an anti-displacement member 11, called a center pin, which is provided at the distal end of the cylinder 3a. The anti-displacement member 11 for preventing the upper shutter member 7U from being disengaged from the cylinder 3a due to displacement is secured by welding at the distal end of the cylinder 3a with the hole formed in the upper shutter member 7U being fitted over the cylinder 3a.

In this way, the upper shutter member 7U is supported by the anti-displacement member 11. Then, the hole of the upper shutter member 7U is guided by the outer surface of the cylinder 3a during rotation of the upper shutter member 7U. Since the upper shutter member 7U is joined to the lower shutter member 7D, when the upper shutter member 7U is rotated while being guided by the cylinder 3a, the lower shutter member 7D is also rotated as one with the upper shutter member while being guided by the cylinder 3a. Therefore, a rotatably holding mechanism for rotatably holding the lower shutter member 7D becomes unnecessary. This eliminate the necessity of caulking the lower shutter member which is the main factor causing the sliding friction when rotating the rotary shutter, whereby smooth movement of the rotary shutter can be achieved.

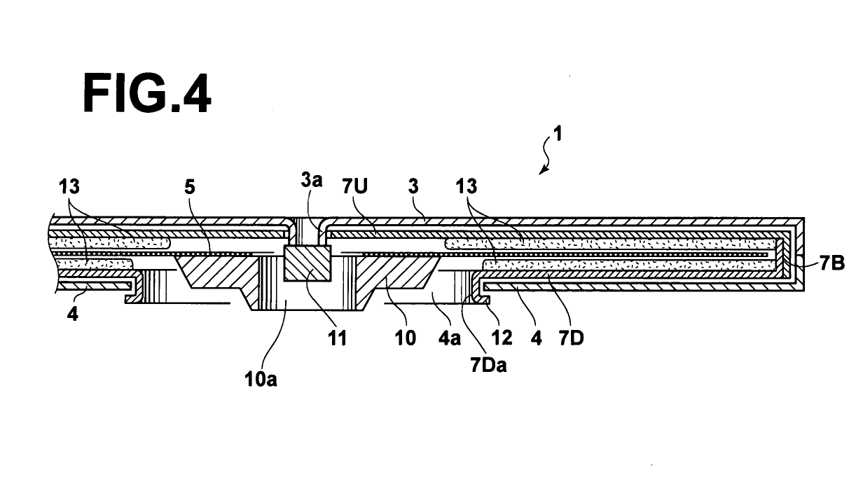

In the conventional disk cartridge as shown in FIG. 4, the upper shutter member 7U and the lower shutter member 7D are not joined but engaged with one another, and therefore the lower shutter member and the lower shutter shell 4 are caulked. For this reason, when the lower shutter member 7D rotates with respect to the lower shell 4, the caulked portion exhibits sliding friction and produces dust particles as a result of wear due to such frictional sliding. Such dust particles produce resistance to rotation of the lower shutter member 7D, which makes the lower shutter member 7D difficult to rotate. Entering into the housing through the center hole, the dust particles are deposited on the information recording medium 5 and disturb the recording and reproducing of information. Particularly, when the recording density of the information recording medium 5 is enhanced to provide larger capacity, even minute dust particles disturb recording and reproducing.

In contrast, in the disk cartridge 1 shown in FIG. 3, the upper shutter member 7U and the lower shutter member 7D are joined to one another and a rotatably holding member 20 is provided only on the upper shell in order to hold the upper shutter member 7U, thereby eliminating the need to caulk the lower shell 4 and the lower shutter member 7D. This prevents the dust particles from being produced due to sliding between the lower shell 4 and the lower shutter member 7D, and thus prevents the rotation of the rotary shutter 7 from being disturbed. By providing the rotatably holding member 20 only on the lower shell 4 may cause dust particles, produced due to wear, to enter the interior of the housing through the center hole 4a formed in the lower shell 4 and become deposited on the surface of the information recording medium 5. However, when the rotatably holding member 20 is provided only on the upper shell 3, undesired entry of the dust particles into the housing is avoided, which is preferable for enhancing the recording density of the information recording medium 5 to provide a larger capacity.

A cylindrical portion 7Da to be fitted in the center hole 4a of the lower shell is provided at the center part of the lower shutter member 7D. When the lower shutter member 7D is rotated, the lower shutter member 7D is guided by the center hole 4a by the cylindrical portion 7Da. This results in rotating the rotary shutter 7 while guiding both the upper shell 3 and lower shell 4, thereby reducing axial (vertical) deflections of the rotary shutter 7 during rotation.

In accordance with the foregoing embodiment, the upper shutter member 7U and lower shutter member 7D of the rotary shutter 7 are joined to one another and the rotary shutter 7 is rotatably held by the rotatably holding portion 20 of the upper shell 3. As a result, a conventional construction, in which the lower shutter member 7D and the lower shell 4 are caulked, becomes unnecessary, which reduces the sliding friction at the caulked portion when opening and closing the rotary shutter 7. Thus smooth opening and closing operations of the rotary shutter are ensured. Further, as described above, the caulked portion between the lower shutter member 7D and the lower shell 4 becomes unnecessary, which avoids production of dust particles as a result of wear due to sliding at the caulked portion and prevents the dust particles from becoming deposited on the information recording medium.

It will be understood that the invention is not restricted to the aforementioned and illustrated embodiment thereof. For example, while the upper and lower shells 3, 4 and the rotary shutter 7 are illustrated as being formed of metallic material in the aforementioned embodiment, they may be formed of plastic material or any other material.

Further, while the cylindrical portion 3a of the upper shell 3 shown in FIG. 3 is illustrated as being formed by burring or deep drawing, the cylindrical portion 3a may be formed separately from the upper shell 3, and secured to the upper shell by welding. The use of welding can improve the rigidity of the upper shell 3 because there is no hole in the upper shell 3 which is formed as a result of burring.

What is claimed is;

1. A disk cartridge comprising: a flat housing having upper and lower shells; and a disk-shaped information-recording medium which has a center core centrally attached thereto and is rotatably accommodated in the flat housing, the housing including an opening to allow a recording/reproducing head of a drive unit to access a surface of the information recording disk, and a rotary shutter for opening and closing the opening,
wherein the housing has a rotatably holding portion for rotatably holding the rotary shutter, the rotatably holding portion being provided only on the upper shell; and
the rotary shutter comprises:
an upper shutter member rotatably held by the rotatably holding portion; and
a lower shutter member joined at the sidewall thereof to the upper shutter member.

2. A disk cartridge according to claim 1, wherein the lower shell has a generally circular center hole for exposing a center core towards the outside, and the lower shutter member has a simple cylindrical portion to be inserted into the center hole.

3. A disk cartridge according to claim 2, wherein:
the rotary holding portion guides the rotational movement of the upper shutter member; and
the cylindrical portion and the center hole guides the rotational movement of the lower shutter member.

4. A disk cartridge according to claim 1, wherein the upper shutter member and the lower shutter member are joined to each other by contiguously joining their entire sidewalls via which they contact each other.

5. A disk cartridge according to claim 1, wherein the upper shutter member and the lower shutter member are joined by joining at least a portion of the sidewalls via which they contact each other.

6. A disk cartridge according to claim 1, wherein:
the rotary shutter further comprises a shutter knob that projects toward the lower shell; and
the lower shell is provided with an arcuate aperture, which is concentric with the rotary shutter, into which the shutter knob is inserted.

7. A disk cartridge according to claim 1, wherein:
the upper shell further comprises a rotatably holding portion formed in the upper shell, the rotatably holding portion comprising a cylinder that projects toward the upper shutter member from the upper shell and an anti-displacement member provided at the distal end of the cylinder; and
the upper shutter member is provided with a hole for the cylinder to be inserted into; wherein the anti-displacement member is provided at the distal end of the cylinder in a state in which the cylinder is inserted within the hole.

8. A disk cartridge according to claim 1, wherein the upper shell, the lower shell, the upper shutter member, and the lower shutter member are formed by thin metal plates.

9. A disk cartridge according to claim 8, wherein the upper shell and the lower shell are joined by laser welding; and the upper shutter member and the lower shutter member are joined by laser welding the sidewalls thereof.
